(19) United States
(12) Patent Application Publication
(10) Pub. No.: US 2020/0243067 A1
(43) Pub. Date: Jul. 30, 2020

(54) ENVIRONMENT CLASSIFIER FOR DETECTION OF LASER-BASED AUDIO INJECTION ATTACKS

(71) Applicant: Intel Corporation, Santa Clara, CA (US)

(72) Inventors: Przemyslaw Maziewski, Gdansk (PL); Jan Banas, Gdansk (PL); Piotr Klinke, Szczecin (PL); Damian Koszewski, Gdansk (PL); Pawel Pach, Gdansk (PL); Dominik Stanczak, Gdansk (PL); Pawel Trella, Gdansk (PL)

(73) Assignee: Intel Corportation, Santa Clara, CA (US)

(21) Appl. No.: 16/849,525

(22) Filed: Apr. 15, 2020

(51) Int. Cl. G10L 15/02; G10L 15/04

(52) U.S. Cl. CPC G10L 15/02; G10L 2021/02166; G10L 15/04

(57) ABSTRACT

Techniques are provided for detection of laser-based audio injection attacks through classification of the acoustic environment. A methodology implementing the techniques according to an embodiment includes broadcasting a reference signal over a loudspeaker into a local environment, and generating a reference model of the local environment based on analysis of a transformed version of that reference signal received through a microphone of the device. The method further includes generating an estimate model based on analysis of a segment of speech in an audio signal received through the microphone. The estimate model is associated with an environment in which the speech was generated. The method further includes calculating a similarity metric (e.g., mathematical distance) between the reference model and the estimate model, and providing warning of a laser-based audio attack if the similarity metric exceeds a threshold value associated with an attack.

### BACKGROUND

Voice-controlled systems and devices, which perform actions based on recognized speech from a user, are becoming increasingly popular. As these systems achieve wide spread use, laser-based audio injection attacks are posing a new and growing threat. This type of attack uses a laser signal to inject malicious commands into a microphone of the voice-controlled system. The laser signal is inaudible and can be effective at relatively large distances, which makes these attacks difficult to detect. For this reason, most currently available voice-controlled systems and devices are likely vulnerable to such attacks.

### BRIEF DESCRIPTION OF THE DRAWINGS

FIG. 1 illustrates an example laser attack on a speech-enabled device configured in accordance with an embodiment of the present disclosure.

FIG. 2 is a block diagram of the device under attack, configured in accordance with an embodiment of the present disclosure.

FIG. 3 is a block diagram of a laser attack detection circuit, configured in accordance with an embodiment of the present disclosure.

FIG. 4 is a block diagram of a reverberation estimation circuit, configured in accordance with an embodiment of the present disclosure.

FIG. 5 is a block diagram of a recurrent neural network to estimate reverberation, configured in accordance with an embodiment of the present disclosure.

FIG. 6 is a flowchart illustrating a methodology for detection and prevention of laser-based audio attacks, in accordance with an embodiment of the present disclosure.

FIG. 7 is a block diagram schematically illustrating a computing platform configured to perform detection and prevention of laser-based audio attacks, in accordance with an embodiment of the present disclosure.

Although the following Detailed Description will proceed with reference being made to illustrative embodiments, many alternatives, modifications, and variations thereof will be apparent in light of this disclosure.

### DETAILED DESCRIPTION

Techniques are provided for defending against a laser-based audio injection attack that can compromise the security of a speech-enabled or voice-controlled system or device, such as a smart-speaker, personal assistant, home management system, and the like, which are configured to perform actions in response to user spoken requests. These devices are vulnerable, however, to attack from inaudible laser signals which have been modulated by speech that can command the devices to perform unintended and/or malicious tasks. The devices can thus be spoofed into waking from a sleep state and acting on commands embedded in the laser signal, without the user's knowledge. Embodiments of the present disclosure provide techniques for estimating the acoustic environment local to the speech-enabled device being protected. Because an attack speech signal will have been recorded in a different location than the room or location in which the device under attack is operating (the local environment), it is possible to differentiate an attack speech signal from legitimate spoken commands from the user, based on analysis of the environment characteristics associated with received audio signals. In some embodiments, environment characteristics may include reverberation, frequency response, and/or other locally detectable features that can be used to uniquely identify the local environment, as will be described in greater detail below.

The disclosed techniques can be implemented, for example, in a computing system or a software product executable or otherwise controllable by such voice-controlled systems, although other embodiments will be apparent. The system or product is configured to defend against a laser-based audio injection attack on a speech-enabled or voice-controlled device (speech-enabled, going forward). In accordance with such an embodiment, a methodology to implement these techniques includes broadcasting a reference signal over a loudspeaker into a local environment, and generating a reference model of the local environment based on analysis of a transformed version of that reference signal received through a microphone of the device. The method further includes generating an estimate model based on analysis of a segment of speech in an audio signal received through the microphone. The estimate model is associated with an environment in which the speech was generated. The method further includes calculating a similarity metric (e.g., mathematical distance) between the reference model and the estimate model and providing warning of a laser-based audio attack if that metric exceeds a threshold value associated with an attack. In some embodiments, the reference model may be updated based on the estimate model, if the distance or other similarity metric does not exceed the threshold value.

As will be appreciated, the techniques described herein may provide an improved defense against laser-based audio injection attack, compared to existing techniques that employ a masking mesh to attempt to block the laser beam, which can be defeated by increasing the power of the laser, or that use microphone arrays, which can be defeated by broadening the beam of the laser. The disclosed techniques can be implemented on a broad range of platforms including home management systems, workstations, laptops, tablets, and smartphones. These techniques may further be implemented in hardware or software or a combination thereof.

System Architecture

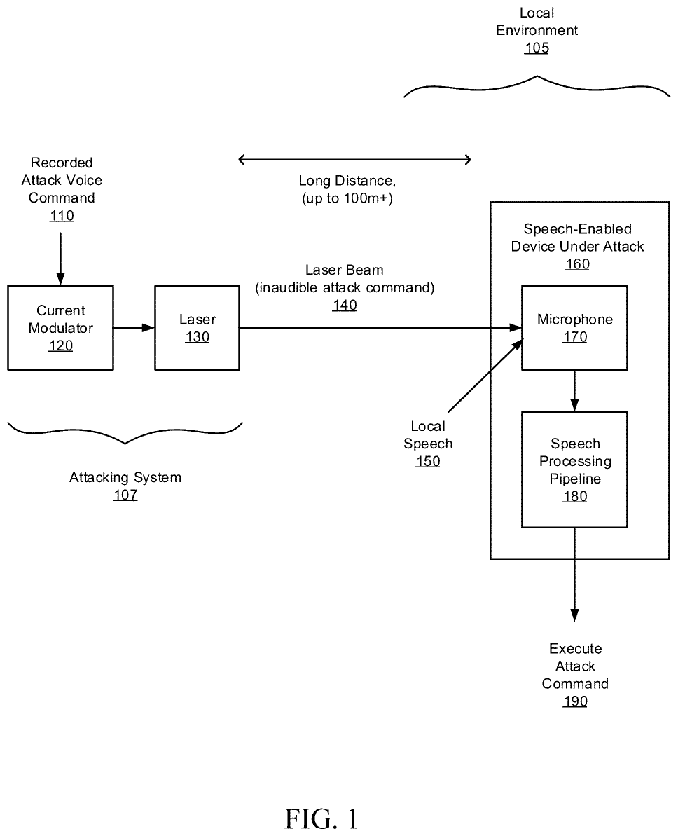

FIG. 1 illustrates a laser attack scenario 100 on a speech-enabled device 160 configured in accordance with an embodiment of the present disclosure. A system configured for implementing the laser-based attack (e.g., the attacking system) 107 is shown to include a current modulator 120 and a laser 130. The speech-enabled device under attack 160 is shown to include a microphone 170 and a speech processing pipeline 180.

During normal operation, the speech-enabled device 160 is configured to receive audio signals containing local speech 150 from a user (or users) of the device 160, in a local environment 105, through the microphone 170. The local environment 105 may typically be a room, an area of a home, a conference room, a workspace, or the like, in which the device 160 and the user are located. In some embodiments, the speech-enabled device 160 may be a smart-speaker, personal assistant, home management system, or any device configured to receive an audio signal containing spoken commands, recognize the commands, and act on those commands, for example through speech processing pipeline 180. In some example embodiments, the device may be connected to the Internet and/or a local network to facilitate the performance of the requested tasks. For example, the user may say “computer, play song xyz,” or “computer, set the temperature to 70 degrees,” or “computer, send the following email to my friend Joe.” In these examples, the term “computer” is used as a wake-up key phrase to get the attention of the device 160, which may have been in a low-power or sleep state. The remaining portion of speech include a command for the device to act upon. In some example embodiments, note that a wake-up key phrase is not needed, in that the device is trained to listen for the user's voice and act on certain commands given by that user (or set of users).

The attacking system 107 is shown to provide a recorded attack voice command 110, to the current modulator 120 that is configured to modulate the laser 130. The resulting modulated laser beam 140 thus carries the attack voice command 110, but is inaudible and can propagate over relatively long distances of 100 meters or more. The laser beam 140 is aimed at the microphone 170, which converts the modulated light into an audio signal through light induced mechanical vibration of the microphone membrane. The attack voice command 110 is thus introduced into the speech processing pipeline 180 as an acoustic signal and may cause the speech-enabled device 160 to execute the attack command 190 to perform malicious tasks without the knowledge of the user. For example, attack commands may be provided to instruct the device 160 to transfer sensitive information to unauthorized recipients or to perform fraudulent financial transactions.

The attacking system 107 may be located at a certain distance from the device 160, which may range from being relatively close, to relatively far away (e.g., up to 100 meters or more), depending on the propagation properties of the laser beam and the availability of a clear line of sight to the microphone of the device 160. In contrast, the attack voice command 110 will likely be recorded anywhere other than the local environment 105, as doing otherwise would likely expose the attack operation. Typically, the attack voice command 110 would be recorded at a remote location, such as the base of operation of the hacker or malicious parties perpetrating the attack. Regardless of the location, however, the environment in which that recording is made will be measurably different from the local environment 105.

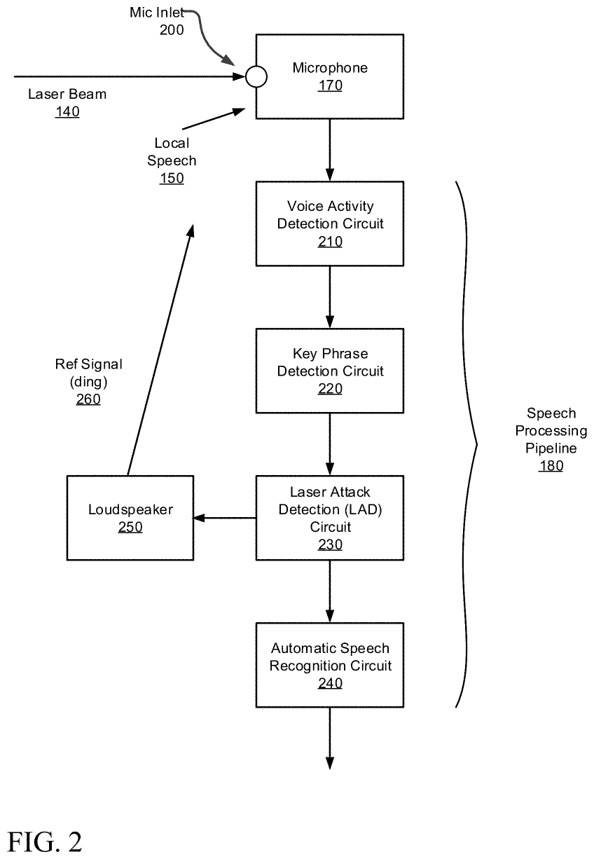

FIG. 2 is a block diagram of the speech-enabled device under attack 160, configured in accordance with an embodiment of the present disclosure. As can be seen, the device 160 of this example embodiment is shown to include microphone 170, voice activity detection circuit 210, key phrase detection circuit 220, laser attack detection (LAD) circuit 230, automatic speech recognition (ASR) circuit 240, and loudspeaker 250.

In some embodiments, microphone 170 can be a single microphone or an array of microphones, and may include analog microphones, digital microphones, electret microphones, and dynamic microphones, to name just a few. Microphone(s) 170 comprises a number of microphone inlets 200 on the outer surface of the microphone. During normal operation, acoustic vibrations associated with the local speech 150 pass through the microphone inlets 200, causing vibration of the microphone membrane which is translated into an electrical signal that represents the acoustic signal. During a laser attack, the laser beam 140 also passes through the microphone inlets 200 and induces mechanical vibration of the microphone membrane which is translated into an electrical signal that represents the attack voice command 110. These signals, whether legitimate local speech 150 or attack voice commands 110, are passed on to the speech processing pipeline 180.

Voice activity detection circuit 210 is configured to detect the presence of speech (e.g., voice activity) in the signal provided by microphone 170, to serve, for example, as a trigger to initiate further processing in the pipeline 180. Voice activity detection can be performed using any suitable technique in light of the present disclosure.

In some embodiments, key phrase detection circuit 220 may be provided as an optional component configured to detect a key phrase in the detected speech (e.g., a wake-up or wake-on-voice key phrase) as a trigger to initiate further processing in the pipeline 180. Key phrase detection can be performed using any suitable technique in light of the present disclosure.

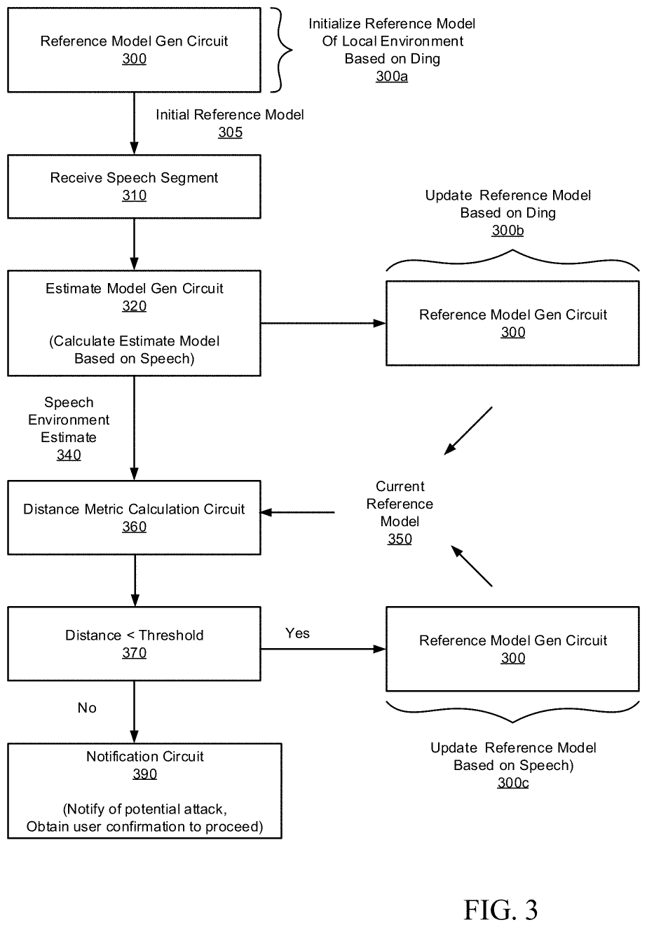

Laser attack detection circuit 230 is configured to detect a laser-based audio injection attack based on analysis of the signals provided from the microphone 170. The operation of laser attack detection circuit 230 will be described in greater detail below in connection with FIG. 3, but at a high-level, the analysis serves to characterize the environment in which the signal was generated, whether local environment 105 associated with legitimate local speech 150, or some other remote environment associated with the recorded attack voice command 110.

ASR circuit 240 is configured to perform speech recognition on the signals provided from the microphone 170, so that recognized speech commands can be acted upon. ASR can be performed using any suitable technique in light of the present disclosure.

FIG. 3 is a block diagram of a laser attack detection circuit 230, configured in accordance with an embodiment of the present disclosure. As can be seen, laser attack detection circuit 230 of this example embodiment is shown to include a reference model generation circuit 300, an estimate model generation circuit 320, a distance metric calculation circuit 360, and a notification circuit 390.

Reference model generation circuit 300 is configured to generate a reference model of the characteristics of the local environment 105. During system initialization 300a, a reference signal (e.g., a “ding” or other similar sound) is transmitted from the loudspeaker 250. The reference signal is transformed by the local environment 105, and the transformed version is received through the microphone 170. The reference model generation circuit 300 generates an initial version of the reference model 305 based on analysis of the transformed version of the reference signal, as will be explained in greater detail below.

During operation of the device 160, speech segments will be received through the microphone 170, including legitimate local speech 150 and possibly attack voice commands 110 delivered on the laser beam 140.

Estimate model generation circuit 320 is configured to generate an estimate model based on analysis of the speech segments, employing the same techniques as used by reference model generation circuit 300, as will be explained below. The estimate model is associated with, and characterizes, the environment in which the speech was generated, for example, either the local environment 105 or the remote environment where the attack voice command was recorded, and is referred to as the speech environment estimate 340.

Because the local environment characteristics can change over time, for example due to people moving about or the device changing location in the room, the reference model generation circuit 300 may update the reference model on occasion to generate a current reference model 350, by re-broadcasting the reference signal and re-analyzing the transformed version of the re-broadcast reference signal. In some embodiments, this may occur periodically or at any suitable interval. In some embodiments, this may occur, for example, at operation 300b, in response to the generation of a new speech environment estimate 340.

Distance metric calculation circuit 360 is configured to calculate a distance metric between the current reference model 350 and the estimate model (i.e., the speech environment estimate 340). Thus, the distance metric calculation circuit 360 determines the similarity (or dissimilarity, as the case may be) between the current reference model 350 and the estimate model 340. For example, in some embodiments, the models 350 and 340 may be expressed as vectors comprising values that represent the model. These values may include reverberation durations, frequency response bins, or other suitable measurements or estimates as explained below. The distance metric may thus be calculated between the vectors for models 350 and 340 as an L2 Norm Euclidean Distance, a Mean Squared Error, a Mean Absolute Distance, or any other suitable measure. In some embodiments, the vector values may be weighted in any desired matter. For example, some frequency bins may be considered to be of greater importance than other frequency bins.

At operation 370, the distance metric as compared to a threshold value that is associated with an attack. Notification circuit 390 is configured to provide a warning of a laser-based audio attack, if the distance metric exceeds the threshold. In some embodiments, the notification circuit 390 may also be configured to obtain confirmation from the user before allowing the device to proceed with execution of a potentially malicious voice command. Confirmation may include asking the user to enter a password, security PIN, or other authentication factor.

In the event that the distance metric does not exceed the threshold, then the speech segment is determined to be legitimate local speech 150. In this case, the reference model generation circuit 300 is further configured to update, at operation 300c, the current reference model 350 based on the estimate model. Said differently, the current reference model, in this case is updated based on analysis of the speech segment rather than a reference signal.

In some embodiments, analysis of the environment characteristics, whether for the reference model or the estimate model, may include analysis of reverberation characteristics, analysis of frequency response, analysis of reverberation decay, and/or analysis of the relationship between direct and reverberant sound, which are described in more detail below. In some embodiments, other suitable environmental characteristics may be used, alone or in combination with one or more of the above, in light of the present disclosure.

Reverberation, which can be used to distinguish malicious speech from legitimate speech, is a physical property of the sound propagation in a given space and therefore its quality depends on the room. For example, reverberation is influenced by the size of the room, the amount and type of finishing materials, the number of people present in the room, etc. It is generally impractical to deduce the reverberation profile of a room based solely on visual assessment or knowledge of the room layout. Rather, acoustic measurements are required to characterize the reverberation qualities of the room environment. As such, hidden malicious commands that were not recorded in the room where the attack takes place will almost always have different reverberation characteristics. In some embodiments, a neural network may be used to estimate the reverberation, as will be described in greater detail below. In some embodiments, reverberation may be calculated in octave bands, third octave bands, or over other spectral divisions (e.g., frequency bins) per time segment of the speech.

Another environmental characteristic that can be used to distinguish speech from an attack is the frequency response of the room. As with reverberation, this response is specific to a particular room. Thus, there is a high probability that the room/environment in which the attack speech was recorded has a different frequency response than the room/environment in which the device under attack is located, thereby filtering the attack speech in a different manner than the legitimate local speech. Therefore, local speech will have a different spectrum than attack speech, and this difference can be measured through spectrum analysis or other suitable techniques in light of the present disclosure.

Still another approach is to analyze the relationship between the amplitude (or power) of direct and reverberant sound. This ratio will generally be specific to the room and the distance between the speaker and the microphone. The attack speech is typically recorded at a specific distance from the microphone (usually a few centimeters using a so called close mike). As a result, the ratio of amplitude of the attack speech direct sound to attack speech reverberation (reflection of this speech from the walls, ceiling, etc.) will be greater than in the case of legitimate local speech generated by a user speaking from a greater distance to the device.

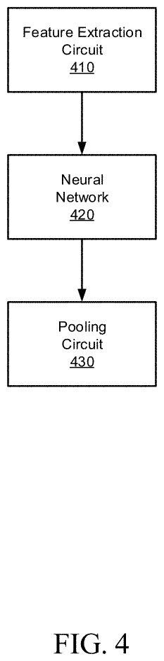

FIG. 4 is a block diagram of a reverberation estimation circuit 400, configured in accordance with an embodiment of the present disclosure. As can be seen, the reverberation estimation circuit 400 of this example embodiment is shown to include a feature extraction circuit 410, a neural network 420 (which may be a recurrent neural network (RNN)), and a pooling circuit 430, although other configurations and types of neural networks, including convolutional neural networks (CNNs), are possible.

Feature extraction circuit 410 is configured to extract features from segments of the input audio data. The features (or vectors of features) may include any suitable features that are representative of acoustic properties of the speech which are of interest, and the features may be extracted using Mel-Frequency Cepstral Coefficients (MFCC) or any other suitable techniques in light of the present disclosure. In some embodiments, for example, 64 features may be extracted for short time frames of 400 samples length, with 160 sample offsets.

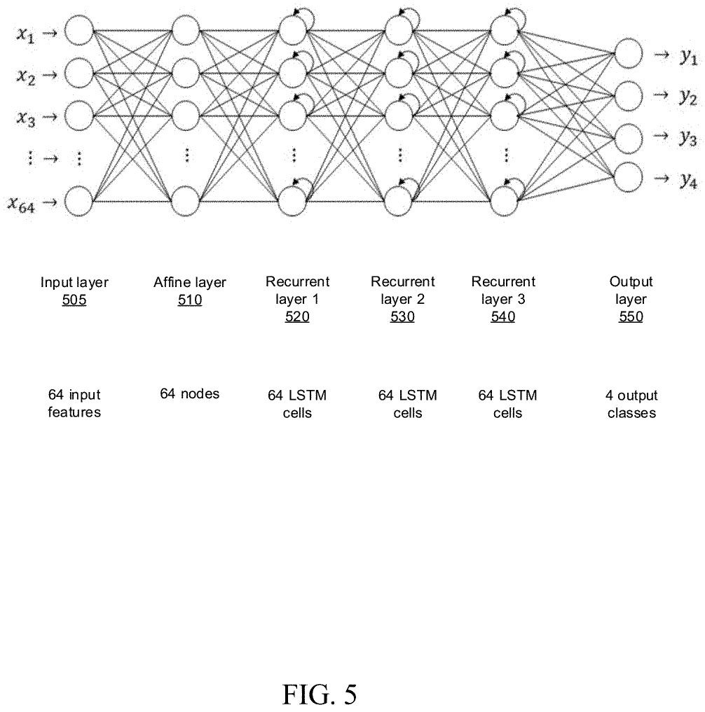

Neural network 420 is configured to operate on the features from each input frame and classify the reverberation of the frame into one or more classes. Operation and training of an embodiment of the neural network 420 will be explained in greater detail below in connection with FIG. 5.

Pooling circuit 430 is configured to average the classification results over a selected time interval (e.g., the duration of the key phrase or speech segment), to generate an estimate of the reverberation profile.

In some embodiments, the feature extraction circuit 410 may be omitted and the neural network 420 may operate directly on the input audio data. This may be particularly applicable if the neural network 420 is a CNN, and a larger training data set is available.

FIG. 5 is a block diagram of an RNN 500 to estimate reverberation, configured in accordance with an embodiment of the present disclosure. As can be seen, the RNN 500 of this example embodiment is shown to include an input layer 505, an affine layer 510, a first recurrent layer 520, a second recurrent layer 530, a third recurrent layer 540, and an output layer 550, although other configurations are possible as will be appreciated in light of this disclosure. In this example, the input layer 505 is shown to comprise 64 nodes to accept the 64 provided features. The affine layer also comprises 64 nodes, and the recurrent layers each comprise 64 Long Short-Term Memory (LSTM) cells. The output layer comprises 4 nodes, each representing a classification output such as, for example, “short reverberation,” “medium reverberation,” “long reverberation,” and “no recognition,” for example due to lack of speech in the frame. Of course, in some embodiments, the output layer may include many more nodes to provide more output categories/classifications with greater reverberation interval granularity. RNNs employing LSTM cells generally provide high classification accuracy for similar problems that exhibit strong time-variance coupling of the spectral representation (e.g. recognition of acoustic events or time-frequency masking).

In some embodiments, the RNN 500 may be trained on sampled or synthesized training and evaluation data sets. These data sets may be synthesized by convolving a number of speech signals with a number of room impulse responses. Room impulse responses may be obtained from publicly available databases, recorded from actual rooms or offices, or generated using acoustic simulation software.

In some embodiments, neural network 420 may be configured as a mixture of an RNN LSTM and a CNN where, for example, recurrent layers are alternated with convolutional layers.

Methodology

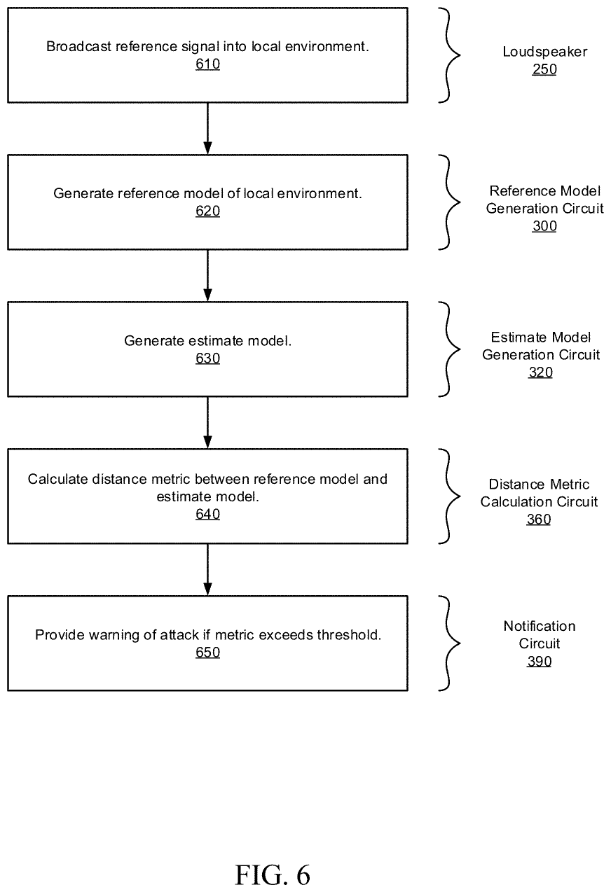

FIG. 6 is a flowchart illustrating a methodology 600 for detection and prevention of laser-based audio attacks, in accordance with an embodiment of the present disclosure. As can be seen, the example method includes a number of phases and sub-processes, the sequence of which may vary from one embodiment to another. However, when considered in the aggregate, these phases and sub-processes form a process for detection and prevention of laser-based audio attacks, in accordance with certain of the embodiments disclosed herein. These embodiments can be implemented, for example, using the system architecture illustrated in FIGS. 1-5, as described above. However other system architectures can be used in other embodiments, as will be apparent in light of this disclosure. To this end, the correlation of the various functions shown in FIG. 6 to the specific components illustrated in the other figures is not intended to imply any structural and/or use limitations. Rather, other embodiments may include, for example, varying degrees of integration wherein multiple functionalities are effectively performed by one system. For example, in an alternative embodiment a single module having decoupled sub-modules can be used to perform all of the functions of method 600. Thus, other embodiments may have fewer or more modules and/or sub-modules depending on the granularity of implementation. In still other embodiments, the methodology depicted can be implemented as a computer program product including one or more non-transitory machine-readable mediums that when executed by one or more processors cause the methodology to be carried out. Numerous variations and alternative configurations will be apparent in light of this disclosure.

As illustrated in FIG. 6, in an embodiment, method 600 for detection and prevention of laser-based audio attacks commences by broadcasting, at operation 610, a reference signal over a loudspeaker into a local environment.

Next, at operation 620, a reference model of the local environment is generated based on analysis of a transformed version of the reference signal received through a microphone of the processor-based system.

At operation 630, an estimate model is generated based on analysis of a segment of speech in an audio signal received through the microphone. The estimate model is associated with an environment in which the speech was generated, which may be the local environment, or in the case of an attack, a different environment.

In some embodiments, the generation of the reference model and/or the estimate model may be based on analysis of reverberation characteristics of the signals (reference signal and/or speech segment). In some embodiments, the generation of the reference model and/or the estimate model may be based on analysis of the frequency response of the environment.

At operation 640, a distance metric, between the reference model and the estimate model, is calculated.

At operation 650, a warning of a laser-based audio attack is provided to the user, if the distance metric exceeds a threshold value associated with an attack. In some embodiments, user confirmation may be obtained before executing commands that are potentially associated with the attack.

Of course, in some embodiments, additional operations may be performed, as previously described in connection with the system. For example, the reference model may be updated based on the estimate model, if the distance metric does not exceed the threshold value. In some embodiments, the reference signal may be re-broadcast over the loudspeaker into the local environment, in response to receiving the segment of speech in the audio signal, and the reference model may then be updated based on analysis of a transformed version of the re-broadcast reference signal received through the microphone.

Example System

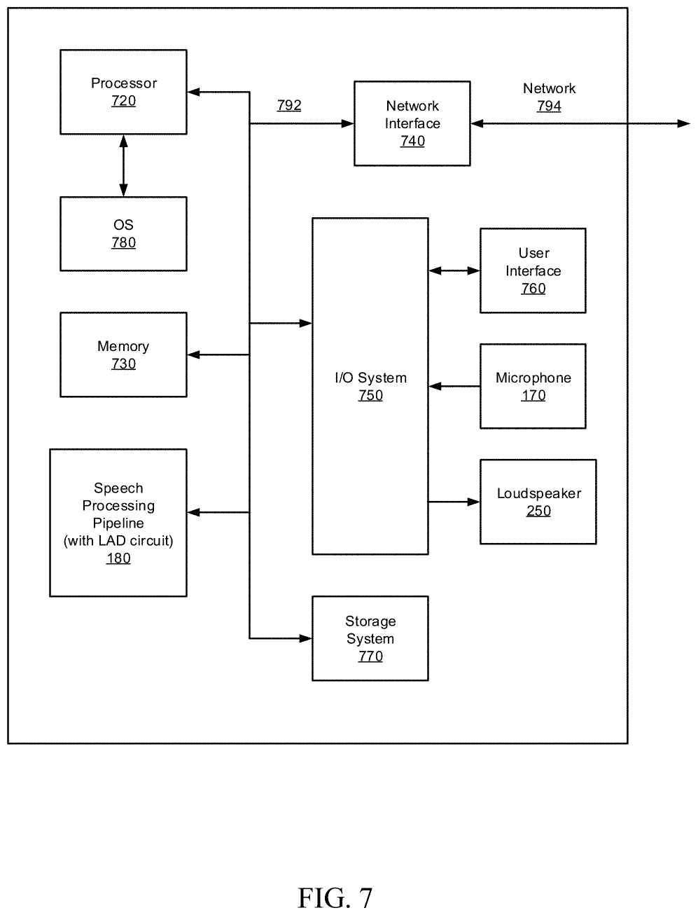

FIG. 7 is a block diagram schematically illustrating an example computing platform 700 configured to perform detection and prevention of laser-based audio attacks, in accordance with an embodiment of the present disclosure. In some embodiments, platform 700 may be a dedicated speech-enabled device or a speech-enabled device (e.g., 160) that is hosted on, or otherwise incorporated into a personal computer, workstation, server system, laptop computer, ultra-laptop computer, tablet, touchpad, portable computer, handheld computer, palmtop computer, personal digital assistant (PDA), cellular telephone, combination cellular telephone and PDA, smart device (for example, smartphone, smart-speaker, or smart-tablet), mobile internet device (MID), messaging device, data communication device, wearable device, embedded system, home management system, and so forth. Any combination of different devices may be used in certain embodiments.

In some embodiments, platform 700 may comprise any combination of a processor 720, a memory 730, a speech processing pipeline 180 including laser attack detection circuit 230, a network interface 740, an input/output (I/O) system 750, a user interface 760, a microphone 170, a loudspeaker 250, and a storage system 770. As can be further seen, a bus and/or interconnect 792 is also provided to allow for communication between the various components listed above and/or other components not shown. Platform 700 can be coupled to a network 794 through network interface 740 to allow for communications with other computing devices, platforms, devices to be controlled, or other resources. Other componentry and functionality not reflected in the block diagram of FIG. 7 will be apparent in light of this disclosure, and it will be appreciated that other embodiments are not limited to any particular hardware configuration.

Processor 720 can be any suitable processor, and may include one or more coprocessors or controllers, such as an audio processor, a graphics processing unit, or hardware accelerator, to assist in control and processing operations associated with platform 700. In some embodiments, the processor 720 may be implemented as any number of processor cores. The processor (or processor cores) may be any type of processor, such as, for example, a micro-processor, an embedded processor, a digital signal processor (DSP), a graphics processor (GPU), a tensor processing unit (TPU), a network processor, a field programmable gate array or other device configured to execute code. The processors may be multithreaded cores in that they may include more than one hardware thread context (or “logical processor”) per core. Processor 720 may be implemented as a complex instruction set computer (CISC) or a reduced instruction set computer (RISC) processor. In some embodiments, processor 720 may be configured as an x86 instruction set compatible processor.

Memory 730 can be implemented using any suitable type of digital storage including, for example, flash memory and/or random-access memory (RAM). In some embodiments, the memory 730 may include various layers of memory hierarchy and/or memory caches as are known to those of skill in the art. Memory 730 may be implemented as a volatile memory device such as, but not limited to, a RAM, dynamic RAM (DRAM), or static RAM (SRAM) device. Storage system 770 may be implemented as a non-volatile storage device such as, but not limited to, one or more of a hard disk drive (HDD), a solid-state drive (SSD), a universal serial bus (USB) drive, an optical disk drive, tape drive, an internal storage device, an attached storage device, flash memory, battery backed-up synchronous DRAM (SDRAM), and/or a network accessible storage device. In some embodiments, storage 770 may comprise technology to increase the storage performance enhanced protection for valuable digital media when multiple hard drives are included.

Processor 720 may be configured to execute an Operating System (OS) 780 which may comprise any suitable operating system, such as Google Android (Google Inc., Mountain View, Calif.), Microsoft Windows (Microsoft Corp., Redmond, Wash.), Apple OS X (Apple Inc., Cupertino, Calif.), Linux, or a real-time operating system (RTOS). As will be appreciated in light of this disclosure, the techniques provided herein can be implemented without regard to the particular operating system provided in conjunction with platform 700, and therefore may also be implemented using any suitable existing or subsequently-developed platform.

Network interface circuit 740 can be any appropriate network chip or chipset which allows for wired and/or wireless connection between other components of platform 700 and/or network 794, thereby enabling platform 700 to communicate with other local and/or remote computing systems, servers, cloud-based servers, and/or other resources. Wired communication may conform to existing (or yet to be developed) standards, such as, for example, Ethernet. Wireless communication may conform to existing (or yet to be developed) standards, such as, for example, cellular communications including LTE (Long Term Evolution) and 5G, Wireless Fidelity (Wi-Fi), Bluetooth, and/or Near Field Communication (NFC). Exemplary wireless networks include, but are not limited to, wireless local area networks, wireless personal area networks, wireless metropolitan area networks, cellular networks, and satellite networks.

I/O system 750 may be configured to interface between various I/O devices and other components of platform 700. I/O devices may include, but not be limited to, user interface 760, microphone 170, and loudspeaker 250. User interface 760 may include devices (not shown) such as a display element, touchpad, keyboard, and mouse, etc. I/O system 750 may include a graphics subsystem configured to perform processing of images for rendering on the display element. Graphics subsystem may be a graphics processing unit or a visual processing unit (VPU), for example. An analog or digital interface may be used to communicatively couple graphics subsystem and the display element. For example, the interface may be any of a high definition multimedia interface (HDMI), DisplayPort, wireless HDMI, and/or any other suitable interface using wireless high definition compliant techniques. In some embodiments, the graphics subsystem could be integrated into processor 720 or any chipset of platform 700.

It will be appreciated that in some embodiments, the various components of platform 700 may be combined or integrated in a system-on-a-chip (SoC) architecture. In some embodiments, the components may be hardware components, firmware components, software components or any suitable combination of hardware, firmware or software.

Laser attack detection circuit 230 of the speech processing pipeline 180 is configured to detect and prevent a laser-based audio attack, as described previously. Laser attack detection circuit 230 may include any or all of the circuits/components illustrated in FIGS. 3-5, as described above. These components can be implemented or otherwise used in conjunction with a variety of suitable software and/or hardware that is coupled to or that otherwise forms a part of platform 700. These components can additionally or alternatively be implemented or otherwise used in conjunction with user I/O devices that are capable of providing information to, and receiving information and commands from, a user.

In some embodiments, these circuits may be installed local to platform 700, as shown in the example embodiment of FIG. 7. Alternatively, platform 700 can be implemented in a client-server arrangement wherein at least some functionality associated with these circuits is provided to platform 700 using an applet, such as a JavaScript applet, or other downloadable module or set of sub-modules. Such remotely accessible modules or sub-modules can be provisioned in real-time, in response to a request from a client computing system for access to a given server having resources that are of interest to the user of the client computing system. In such embodiments, the server can be local to network 794 or remotely coupled to network 794 by one or more other networks and/or communication channels. In some cases, access to resources on a given network or computing system may require credentials such as usernames, passwords, and/or compliance with any other suitable security mechanism.

In various embodiments, platform 700 may be implemented as a wireless system, a wired system, or a combination of both. When implemented as a wireless system, platform 700 may include components and interfaces suitable for communicating over a wireless shared media, such as one or more antennae, transmitters, receivers, transceivers, amplifiers, filters, control logic, and so forth. An example of wireless shared media may include portions of a wireless spectrum, such as the radio frequency spectrum and so forth. When implemented as a wired system, platform 700 may include components and interfaces suitable for communicating over wired communications media, such as input/output adapters, physical connectors to connect the input/output adaptor with a corresponding wired communications medium, a network interface card (NIC), disc controller, video controller, audio controller, and so forth. Examples of wired communications media may include a wire, cable metal leads, printed circuit board (PCB), backplane, switch fabric, semiconductor material, twisted pair wire, coaxial cable, fiber optics, and so forth.

Various embodiments may be implemented using hardware elements, software elements, or a combination of both. Examples of hardware elements may include processors, microprocessors, circuits, circuit elements (for example, transistors, resistors, capacitors, inductors, and so forth), integrated circuits, ASICs, programmable logic devices, digital signal processors, FPGAs, logic gates, registers, semiconductor devices, chips, microchips, chipsets, and so forth. Examples of software may include software components, programs, applications, computer programs, application programs, system programs, machine programs, operating system software, middleware, firmware, software modules, routines, subroutines, functions, methods, procedures, software interfaces, application program interfaces, instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power level, heat tolerances, processing cycle budget, input data rates, output data rates, memory resources, data bus speeds, and other design or performance constraints.

Some embodiments may be described using the expression “coupled” and “connected” along with their derivatives. These terms are not intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still cooperate or interact with each other.

The various embodiments disclosed herein can be implemented in various forms of hardware, software, firmware, and/or special purpose processors. For example, in one embodiment at least one non-transitory computer readable storage medium has instructions encoded thereon that, when executed by one or more processors, cause one or more of the methodologies disclosed herein to be implemented. The instructions can be encoded using a suitable programming language, such as C, C++, object oriented C, Java, JavaScript, Visual Basic .NET, Beginner's All-Purpose Symbolic Instruction Code (BASIC), or alternatively, using custom or proprietary instruction sets. The instructions can be provided in the form of one or more computer software applications and/or applets that are tangibly embodied on a memory device, and that can be executed by a computer having any suitable architecture. In one embodiment, the system can be hosted on a given website and implemented, for example, using JavaScript or another suitable browser-based technology. For instance, in certain embodiments, the system may leverage processing resources provided by a remote computer system accessible via network 794. The computer software applications disclosed herein may include any number of different modules, sub-modules, or other components of distinct functionality, and can provide information to, or receive information from, still other components. These modules can be used, for example, to communicate with input and/or output devices such as a display screen, a touch sensitive surface, a printer, and/or any other suitable device. Other componentry and functionality not reflected in the illustrations will be apparent in light of this disclosure, and it will be appreciated that other embodiments are not limited to any particular hardware or software configuration. Thus, in other embodiments platform 700 may comprise additional, fewer, or alternative subcomponents as compared to those included in the example embodiment of FIG. 7.

The aforementioned non-transitory computer readable medium may be any suitable medium for storing digital information, such as a hard drive, a server, a flash memory, and/or random-access memory (RAM), or a combination of memories. In alternative embodiments, the components and/or modules disclosed herein can be implemented with hardware, including gate level logic such as a field-programmable gate array (FPGA), or alternatively, a purpose-built semiconductor such as an application-specific integrated circuit (ASIC). Still other embodiments may be implemented with a microcontroller having a number of input/output ports for receiving and outputting data, and a number of embedded routines for carrying out the various functionalities disclosed herein. It will be apparent that any suitable combination of hardware, software, and firmware can be used, and that other embodiments are not limited to any particular system architecture.

Some embodiments may be implemented, for example, using a machine readable medium or article which may store an instruction or a set of instructions that, if executed by a machine, may cause the machine to perform a method, process, and/or operations in accordance with the embodiments. Such a machine may include, for example, any suitable processing platform, computing platform, computing device, processing device, computing system, processing system, computer, process, or the like, and may be implemented using any suitable combination of hardware and/or software. The machine readable medium or article may include, for example, any suitable type of memory unit, memory device, memory article, memory medium, storage device, storage article, storage medium, and/or storage unit, such as memory, removable or non-removable media, erasable or non-erasable media, writeable or rewriteable media, digital or analog media, hard disk, floppy disk, compact disk read only memory (CD-ROM), compact disk recordable (CD-R) memory, compact disk rewriteable (CD-RW) memory, optical disk, magnetic media, magneto-optical media, removable memory cards or disks, various types of digital versatile disk (DVD), a tape, a cassette, or the like. The instructions may include any suitable type of code, such as source code, compiled code, interpreted code, executable code, static code, dynamic code, encrypted code, and the like, implemented using any suitable high level, low level, object oriented, visual, compiled, and/or interpreted programming language.

Unless specifically stated otherwise, it may be appreciated that terms such as “processing,” “computing,” “calculating,” “determining,” or the like refer to the action and/or process of a computer or computing system, or similar electronic computing device, that manipulates and/or transforms data represented as physical quantities (for example, electronic) within the registers and/or memory units of the computer system into other data similarly represented as physical entities within the registers, memory units, or other such information storage transmission or displays of the computer system. The embodiments are not limited in this context.

The terms “circuit” or “circuitry,” as used in any embodiment herein, are functional and may comprise, for example, singly or in any combination, hardwired circuitry, programmable circuitry such as computer processors comprising one or more individual instruction processing cores, state machine circuitry, and/or firmware that stores instructions executed by programmable circuitry. The circuitry may include a processor and/or controller configured to execute one or more instructions to perform one or more operations described herein. The instructions may be embodied as, for example, an application, software, firmware, etc. configured to cause the circuitry to perform any of the aforementioned operations. Software may be embodied as a software package, code, instructions, instruction sets and/or data recorded on a computer-readable storage device. Software may be embodied or implemented to include any number of processes, and processes, in turn, may be embodied or implemented to include any number of threads, etc., in a hierarchical fashion. Firmware may be embodied as code, instructions or instruction sets and/or data that are hard-coded (e.g., nonvolatile) in memory devices. The circuitry may, collectively or individually, be embodied as circuitry that forms part of a larger system, for example, an integrated circuit (IC), an application-specific integrated circuit (ASIC), a system-on-a-chip (SoC), desktop computers, laptop computers, tablet computers, servers, smartphones, etc. Other embodiments may be implemented as software executed by a programmable control device. In such cases, the terms “circuit” or “circuitry” are intended to include a combination of software and hardware such as a programmable control device or a processor capable of executing the software. As described herein, various embodiments may be implemented using hardware elements, software elements, or any combination thereof. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth.

Numerous specific details have been set forth herein to provide a thorough understanding of the embodiments. It will be understood by an ordinarily-skilled artisan, however, that the embodiments may be practiced without these specific details. In other instances, well known operations, components and circuits have not been described in detail so as not to obscure the embodiments. It can be appreciated that the specific structural and functional details disclosed herein may be representative and do not necessarily limit the scope of the embodiments. In addition, although the subject matter has been described in language specific to structural features and/or methodological acts, it is to be understood that the subject matter defined in the appended claims is not necessarily limited to the specific features or acts described herein. Rather, the specific features and acts described herein are disclosed as example forms of implementing the claims.

Further Example Embodiments

The following examples pertain to further embodiments, from which numerous permutations and configurations will be apparent.

Example 1 is a processor-implemented method for prevention of laser-based audio attacks, the method comprising: broadcasting, by a processor-based system, a reference signal over a loudspeaker into a local environment; generating, by the processor-based system, a reference model of the local environment based on analysis of a transformed version of the reference signal received through a microphone of the processor-based system; generating, by the processor-based system, an estimate model based on analysis of a segment of speech in an audio signal received through the microphone, the estimate model associated with an environment in which the speech was generated; calculating, by the processor-based system, a similarity metric between the reference model and the estimate model; and providing, by the processor-based system, warning of a laser-based audio attack, if the similarity metric exceeds a threshold value associated with an attack.

Example 2 includes the subject matter of Example 1, further comprising updating the reference model based on the estimate model, if the similarity metric does not exceed the threshold value.

Example 3 includes the subject matter of Examples 1 or 2, further comprising: re-broadcasting the reference signal over the loudspeaker into the local environment, in response to receiving the segment of speech in the audio signal; and updating the reference model based on analysis of a transformed version of the re-broadcast reference signal received through the microphone.

Example 4 includes the subject matter of any of Examples 1-3, wherein the reference model and the estimate model are based on analysis of reverberation characteristics.

Example 5 includes the subject matter of any of Examples 1-4, wherein the analysis of reverberation characteristics is performed by a recurrent neural network employing Long Short-Term Memory cells.

Example 6 includes the subject matter of any of Examples 1-5, wherein the reference model and the estimate model are based on analysis of environment frequency response.

Example 7 includes the subject matter of any of Examples 1-6, wherein the segment of speech is a wake-on-voice key phrase.

Example 8 is at least one non-transitory machine-readable storage medium having instructions encoded thereon that, when executed by one or more processors, cause a process to be carried out for prevention of laser-based audio attacks, the process comprising: broadcasting a reference signal over a loudspeaker into a local environment; generating a reference model of the local environment based on analysis of a transformed version of the reference signal received through a microphone of the processor-based system; generating an estimate model based on analysis of a segment of speech in an audio signal received through the microphone, the estimate model associated with an environment in which the speech was generated; calculating a similarity metric between the reference model and the estimate model; and providing warning of a laser-based audio attack, if the similarity metric exceeds a threshold value associated with an attack.

Example 9 includes the subject matter of Example 8, wherein the process further comprises updating the reference model based on the estimate model, if the similarity metric does not exceed the threshold value.

Example 10 includes the subject matter of Examples 8 or 9, wherein the process further comprises: re-broadcasting the reference signal over the loudspeaker into the local environment, in response to receiving the segment of speech in the audio signal; and updating the reference model based on analysis of a transformed version of the re-broadcast reference signal received through the microphone.

Example 11 includes the subject matter of any of Examples 8-10, wherein the reference model and the estimate model are based on analysis of reverberation characteristics.

Example 12 includes the subject matter of any of Examples 8-11, wherein the analysis of reverberation characteristics is performed by a recurrent neural network employing Long Short-Term Memory cells.

Example 13 includes the subject matter of any of Examples 8-12, wherein the reference model and the estimate model are based on analysis of environment frequency response.

Example 14 includes the subject matter of any of Examples 8-13, wherein the segment of speech is a wake-on-voice key phrase.

Example 15 is a system for prevention of laser-based audio attacks, the system comprising: a reference model generation circuit to generate a reference model of a local environment based on analysis of a transformed version of a reference signal received through a microphone of the system, the reference signal broadcast over a loudspeaker into the local environment; an estimate model generation circuit to generate an estimate model based on analysis of a segment of speech in an audio signal received through the microphone, the estimate model associated with an environment in which the speech was generated; a distance metric calculation circuit to calculate a distance metric between the reference model and the estimate model; and a notification circuit to provide warning of a laser-based audio attack, if the distance metric exceeds a threshold value associated with an attack.

Example 16 includes the subject matter of Example 15, wherein the reference model generation circuit is further to update the reference model based on the estimate model, if the distance metric does not exceed the threshold value.

Example 17 includes the subject matter of Examples 15 or 16, wherein the reference model generation circuit is further to update the reference model based on analysis of a transformed version of a re-broadcast reference signal received through the microphone, the re-broadcast reference signal transmitted over the loudspeaker into the local environment, in response to receiving the segment of speech in the audio signal.

Example 18 includes the subject matter of any of Examples 15-17, wherein the reference model and the estimate model are based on analysis of reverberation characteristics.

Example 19 includes the subject matter of any of Examples 15-18, wherein the reference model generation circuit and the estimate model generation circuit further comprise a recurrent neural network employing Long Short-Term Memory cells to perform the analysis of reverberation characteristics.

Example 20 includes the subject matter of any of Examples 15-19, wherein the reference model and the estimate model are based on analysis of environment frequency response.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents. Various features, aspects, and embodiments have been described herein. The features, aspects, and embodiments are susceptible to combination with one another as well as to variation and modification, as will be understood by those having skill in the art. The present disclosure should, therefore, be considered to encompass such combinations, variations, and modifications. It is intended that the scope of the present disclosure be limited not by this detailed description, but rather by the claims appended hereto. Future filed applications claiming priority to this application may claim the disclosed subject matter in a different manner, and may generally include any set of one or more elements as variously disclosed or otherwise demonstrated herein.

What is claimed is:

1. A processor-implemented method for prevention of laser-based audio attacks, the method comprising:
broadcasting, by a processor-based system, a reference signal over a loudspeaker into a local environment;
generating, by the processor-based system, a reference model of the local environment based on analysis of a transformed version of the reference signal received through a microphone of the processor-based system;
generating, by the processor-based system, an estimate model based on analysis of a segment of speech in an audio signal received through the microphone, the estimate model associated with an environment in which the speech was generated;
calculating, by the processor-based system, a similarity metric between the reference model and the estimate model; and
providing, by the processor-based system, warning of a laser-based audio attack, if the similarity metric exceeds a threshold value associated with an attack.

2. The method of claim 1, further comprising updating the reference model based on the estimate model, if the similarity metric does not exceed the threshold value.

3. The method of claim 1, further comprising:
re-broadcasting the reference signal over the loudspeaker into the local environment, in response to receiving the segment of speech in the audio signal; and
updating the reference model based on analysis of a transformed version of the re-broadcast reference signal received through the microphone.

4. The method of claim 1, wherein the reference model and the estimate model are based on analysis of reverberation characteristics.

5. The method of claim 4, wherein the analysis of reverberation characteristics is performed by a recurrent neural network employing Long Short-Term Memory cells.

6. The method of claim 1, wherein the reference model and the estimate model are based on analysis of environment frequency response.

7. The method of claim 1, wherein the segment of speech is a wake-on-voice key phrase.

8. At least one non-transitory machine-readable storage medium having instructions encoded thereon that, when executed by one or more processors, cause a process to be carried out for prevention of laser-based audio attacks, the process comprising:
broadcasting a reference signal over a loudspeaker into a local environment;
generating a reference model of the local environment based on analysis of a transformed version of the reference signal received through a microphone of the processor-based system;
generating an estimate model based on analysis of a segment of speech in an audio signal received through the microphone, the estimate model associated with an environment in which the speech was generated;
calculating a similarity metric between the reference model and the estimate model; and
providing warning of a laser-based audio attack, if the similarity metric exceeds a threshold value associated with an attack.

9. The computer readable storage medium of claim 8, wherein the process further comprises updating the reference model based on the estimate model, if the similarity metric does not exceed the threshold value.

10. The computer readable storage medium of claim 8, wherein the process further comprises:
re-broadcasting the reference signal over the loudspeaker into the local environment, in response to receiving the segment of speech in the audio signal; and
updating the reference model based on analysis of a transformed version of the re-broadcast reference signal received through the microphone.

11. The computer readable storage medium of claim 8, wherein the reference model and the estimate model are based on analysis of reverberation characteristics.

12. The computer readable storage medium of claim 11, wherein the analysis of reverberation characteristics is performed by a recurrent neural network employing Long Short-Term Memory cells.

13. The computer readable storage medium of claim 8, wherein the reference model and the estimate model are based on analysis of environment frequency response.

14. The computer readable storage medium of claim 8, wherein the segment of speech is a wake-on-voice key phrase.

15. A system for prevention of laser-based audio attacks, the system comprising:
a reference model generation circuit to generate a reference model of a local environment based on analysis of a transformed version of a reference signal received through a microphone of the system, the reference signal broadcast over a loudspeaker into the local environment;
an estimate model generation circuit to generate an estimate model based on analysis of a segment of speech in an audio signal received through the microphone, the estimate model associated with an environment in which the speech was generated;
a distance metric calculation circuit to calculate a distance metric between the reference model and the estimate model; and
a notification circuit to provide warning of a laser-based audio attack, if the distance metric exceeds a threshold value associated with an attack.

16. The system of claim 15, wherein the reference model generation circuit is further to update the reference model based on the estimate model, if the distance metric does not exceed the threshold value.

17. The system of claim 15, wherein the reference model generation circuit is further to update the reference model based on analysis of a transformed version of a re-broadcast reference signal received through the microphone, the re-broadcast reference signal transmitted over the loudspeaker into the local environment, in response to receiving the segment of speech in the audio signal.

18. The system of claim 15, wherein the reference model and the estimate model are based on analysis of reverberation characteristics.

19. The system of claim 18, wherein the reference model generation circuit and the estimate model generation circuit further comprise a recurrent neural network employing Long Short-Term Memory cells to perform the analysis of reverberation characteristics.

20. The system of claim 15, wherein the reference model and the estimate model are based on analysis of environment frequency response.
